(19) United States
(12) Patent Application Publication
(10) Pub. No.: US 2006/0185491 A1
(43) Pub. Date: Aug. 24, 2006

(54) Cutting machine for foodstuffs

(76) Inventor: Hermann Graef, Arnsberg (DE)

Correspondence Address: Stewart L. Gitler;HOFFMAN, WASSON & GITLER, P.C., Suite 522, 2461 South Clark Street, Arlington, VA, 22202, US

(21) Appl. No.: 11/331,353

(22) Filed: Jan. 13, 2006

(30) Foreign Application Priority Data
Jan. 14, 2005 (DE) 10 2005 002 107.7
Sep. 9, 2005 (DE) 10 2005 042 898.3

(51) Int. Cl. B26D 1/00

(52) U.S. Cl. 83/651

(57) ABSTRACT

Cutting machine for foodstuffs, including a rotatable blade, a slide which can be moved to and fro, and a supporting surface for cuttable material to be cut off, which supporting surface is attached movably to the slide and can be transferred from a first position, which encloses an angle not equal to 0° with the horizontal, into a second, horizontal position, the cutting machine having resetting means which, when the supporting surface moves from the first position into the second position, can exert a resetting force on the supporting surface.

### BACKGROUND OF THE INVENTION

The present invention relates to a cutting machine for foodstuffs.

In the case of cutting machines of this type, the supporting surface can be designed as a planar surface. However, there is also the possibility for the bearing surface to be curved or to have a V-shape or to differ in another manner from a planar shape.

A cutting machine of the type mentioned at the beginning is known from GB 619,350 and serves, for example, for cutting sausage or cheese. The cutting machine has a supporting surface which is attached pivotably to a slide and can be fixed in two different positions. In one position, which encloses an angle of between 20° and 30° with the horizontal, the cuttable material can be supplied to the blade in a simpler manner because its dead weight causes it to be pressed onto a rear bearing surface. It is problematic in this connection that cuttable material may under some circumstances adhere to the blade during the cutting movement and so, after having been cut off, the cuttable material may be carried along by the blade.

The problem on which the present invention is based is to provide a cutting machine of the type mentioned at the beginning, in which an undesirable carrying along of the cuttable material by the blade can be prevented or at least reduced.

### SUMMARY OF THE INVENTION

According to the invention, this is achieved by a cutting machine with a rotatable blade, a slide which can be moved to and fro, and a supporting surface for cuttable material to be cut off, which supporting surface is attached movably to the slide and can be transferred from a first position, which encloses an angle not equal to 0° with the horizontal, into a second, horizontal position, the cutting machine having resetting means which, when the supporting surface moves from a first position into the second position, can exert a resetting force on the supporting surface.

The effect achieved by the resetting means which, in preferred embodiments, include spring means or mutually repelling magnets is that the supporting surface is pressed upward from the slide with a predetermined force. During the operation of the cutting machine, the cuttable material and therefore the supporting surface are pressed downward by the cutting force of the rotating blade as the slide moves forward. After a cut slice has been cut off, the supporting surface and the cuttable material are pressed upward and also rearward against the bearing surface by the force of the spring means or the magnets. As a result, for example, cheese is prevented from being drawn rearward by the rotating movement of the blade. The sticky consistency of certain types of cheese could intensify this effect because cheese of this type can adhere briefly to the blade.

There is the possibility in this case of designing the spring means in such a manner or installing them in such a manner that the effective spring force at least partially opposing the pivoting of the supporting surface can be changed. The spring force can thereby be matched to the size, the weight and the consistency of the cuttable material.

There is furthermore the possibility that at least part of the rear bearing surface can be pivoted together with the supporting surface. In this case, the pivotable part of the rear bearing surface can enclose an angle of between 60° and 120°, for example of about 90°, with the supporting surface. As a result, for example, cuttable material with a rectangular contour can always be optimally secured.

In a further embodiment of the present invention, it can be provided that the movable supporting surface can be fixed or locked in the first position or in both positions.

There is furthermore the possibility for the spring means to be designed as a removable spring unit. This enables the spring means to be exchanged in a simple manner.

In addition, it can be provided that the spring means comprise noise-reducing means for damping the connection between the spring means and the supporting surface. As a result, a low-noise operation of the cutting machine can be ensured.

There is furthermore the possibility for the cutting machine to comprise a scraps holder which can be pivoted together with the supporting surface. This makes the handling of the cutting machine more comfortable.

Furthermore, it can be provided that the cutting machine comprises a covering plate which can be attached releasably to the base plate. As a result, structures provided on the base plate can be covered in such a manner that they do not become dirty during operation of the cutting machine.

### BRIEF DESCRIPTION OF THE DRAWINGS

Further features and advantages of the present invention become clear from the description below of preferred exemplary embodiments with reference to the attached figures, in which

FIG. 1 shows a diagrammatic side view of parts of a first embodiment of a cutting machine according to the invention with cuttable material;

FIG. 2 shows a diagrammatic side view of parts of a further embodiment of a cutting machine according to the invention with cuttable material;

FIG. 3 shows a diagrammatic side view of parts of a further embodiment of a cutting machine according to the invention with cuttable material;

FIG. 4 shows a diagrammatic side view of parts of a further embodiment of a cutting machine according to the invention with cuttable material;

FIG. 5 shows a diagrammatic side view of parts of a further embodiment of a cutting machine according to the invention with cuttable material;

FIG. 6 shows a diagrammatic side view of parts of a further embodiment of a cutting machine according to the invention with cuttable material;

FIG. 7 shows a diagrammatic side view of parts of a further embodiment of a cutting machine according to the invention with cuttable material;

FIG. 8 shows a diagrammatic side view of parts of a further embodiment of a cutting machine according to the invention with cuttable material;

FIG. 9 shows a diagrammatic side view of parts of a further embodiment of a cutting machine according to the invention with cuttable material;

FIG. 10 shows a diagrammatic side view of parts of a further embodiment of a cutting machine according to the invention with cuttable material;

FIG. 11 shows a diagrammatic side view of parts of a further embodiment of a cutting machine according to the invention with cuttable material;

FIG. 12 shows a diagrammatic side view of parts of a further embodiment of a cutting machine according to the invention with cuttable material;

FIG. 13 shows a perspective view of the cutting machine according to FIG. 12;

FIG. 14 shows a diagrammatic side view of parts of the cutting machine according to FIG. 12 in various stages of the fastening of the supporting surface;

FIG. 15a shows a diagrammatic side view of parts of the cutting machine according to FIG. 12 in various stages of the fastening of the spring unit;

FIG. 15b shows a diagrammatic plan view of the various stages of the fastening of the spring unit according to FIG. 15a; and

FIG. 15c shows a perspective view of the various stages of the fastening of the spring unit according to FIG. 15a.

### DETAILED DESCRIPTION OF THE DRAWINGS

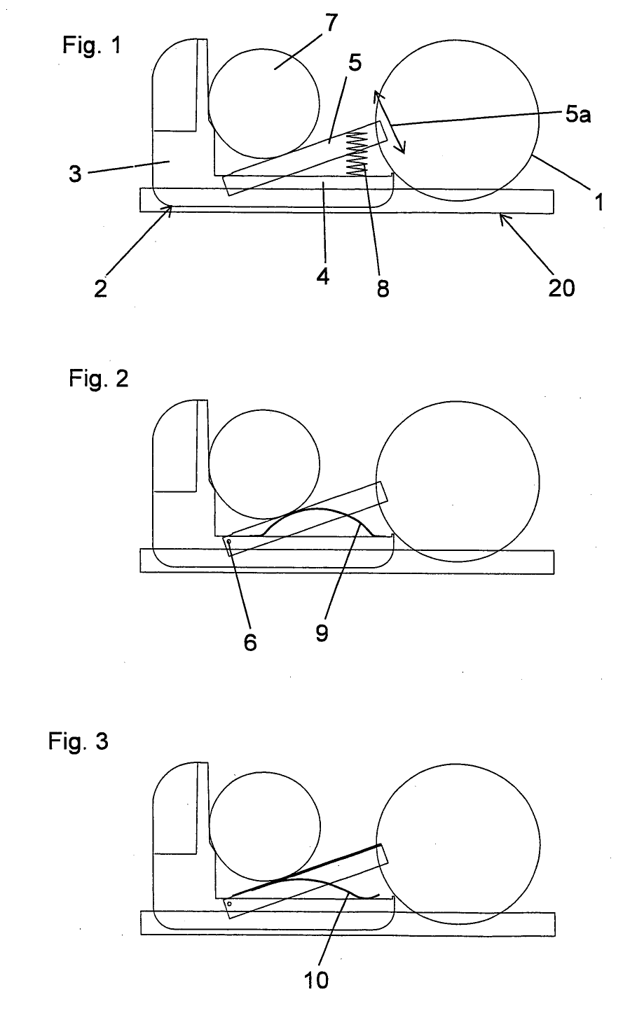

Of the cutting machine according to the invention, only the rotatable blade 1, which is preferably designed as a circulate blade, and a slide mount 20 are depicted in FIG. 1. The blade can rotate about a central axis of rotation in the counterclockwise direction of FIG. 1. A motor with a corresponding housing, and a supporting plate or other stand means are not depicted. Furthermore, a slide 2 which comprises a base plate 4 and a rear bearing surface 3 is depicted.

The slide 2 furthermore comprises a supporting surface 5 which is attached to the base plate 4 and/or to the rear bearing surface 3 in a manner such that it can move about a pivot axis 6 (see FIG. 2 for this). The pivoting of the supporting surface 5 about the pivot axis 6 can take place in the direction of the arrow 5a. FIG. 1 furthermore depicts cuttable material 7 which rests on the supporting surface 5 and bears against the rear bearing surface 3.

The cutting machine furthermore comprises spring means which are designed as spiral springs 8, are arranged between the upper side of the base plate 4 and lower side of the supporting surface 5 and use their spring force to press the supporting surface 5 away from the base plate 4. In the exemplary embodiment depicted, the cuttable material 7 resting on the supporting surface 5 is pressed against the rear bearing surface 3 by the spring means.

In particular, the cuttable material 7 and therefore the supporting surface 5 are pressed downward by the cutting force of the rotating blade 1 as the slide 2 moves forward (to the right in FIG. 1). After a cut slice has been cut off, the supporting surface 5 and the cuttable material 7 are pressed upward and also to the rear against the supporting surface 3 by the spiral spring 8. As a result, for example, cheese is prevented from being drawn to the rear by the rotating movement of the blade 1. The sticky consistency of certain types of cheese could intensify this effect because cheese of this type may briefly adhere to the blade 1.

A scraps holder which can be moved in the direction of the blade 1 (into the plane of projection of FIG. 1) can be provided on the slide 2. In a first embodiment, this scraps holder has a movable bottom plate which can pivot together with the supporting surface 5. In a second embodiment, this scraps holder has a bottom plate running at an angle to the horizontal, with it being possible for this angle to correspond to the maximum pivoting angle (angle between bottom plate 4 and supporting surface 5) of the supporting surface 5.

The supporting surface 5 may be fixable or lockable in a downwardly pivoted, horizontal position on the bottom plate, for example may be fixable by means of a push-push mechanism.

Spring means which differ in design and are embodied in particular as leaf springs 9, 10, 16 can be seen in FIG. 2, FIG. 3 and FIG. 5.

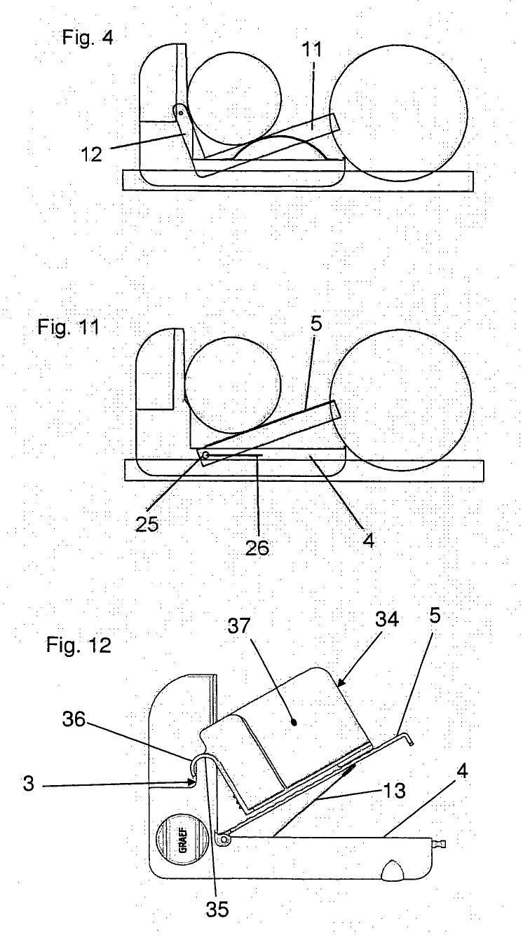

In the case of the embodiment according to FIG. 4, the movable part is of angular design, so that, in addition to the supporting surface 11, part 12 of the rear bearing surface is pivoted at the same time. In this case, the supporting surface 11 and the pivotable part 12 of the rear bearing surface enclose an angle of 90°.

In the case of the embodiment according to FIG. 7, the supporting surface is secured via the spring means, so that it is not absolutely necessary for pivoting to take place about a fixed axis. On the contrary, pivoting can take place about an axis moving during the pivoting operation. In this case, the spring means, in the embodiment according to FIG. 7, are embodied as a leaf spring 24. In particular in the embodiment according to FIG. 7, one end of the leaf spring 24 is attached to the lower side of the movable supporting surface 5 while the other end is attached to the upper side of the base plate 4 of the slide. In this case, at different pivoting angles, a differently sized part of the leaf spring 24 rests on the base plate 4 of the slide, so that the pivot axis migrates to the right or to the left in FIG. 7 during the pivoting.

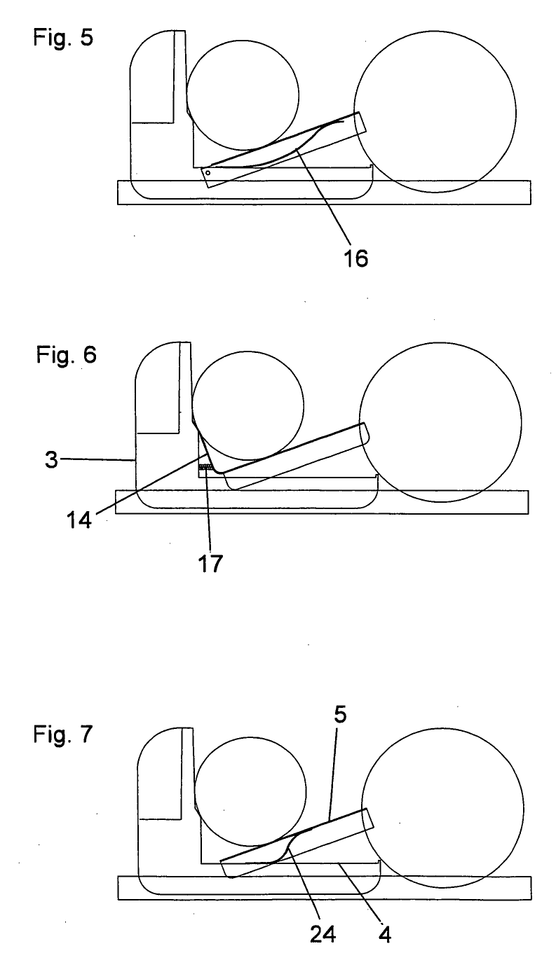

FIG. 6 shows an embodiment in which a spring means embodied as a spiral spring 17 is arranged between a pivotable part 14 of the rear bearing surface and the fixed part 3 of the rear bearing surface.

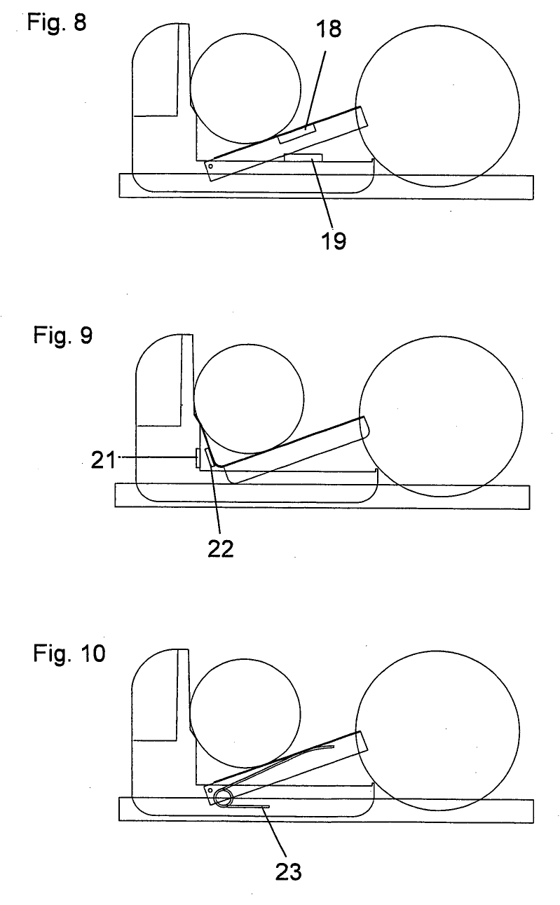

FIG. 8 and FIG. 9 show magnets 18, 19 and 21, 22, respectively, which are respectively attached to the movable parts and to the fixed parts. A coupling between the parts which are movable with respect to one another, which coupling corresponds to that via spring means, is likewise made possible by means of the magnets 18, 19, 21, 22. In this case, the respectively mutually facing sides of the magnets 18, 19, 21, 22 have the same polarity, so that there is a repelling force between them.

FIG. 10 shows a further embodiment of a spring means which is embodied as a spiral spring 23 with two projecting clips.

There is the possibility of designing the spring means in such a manner or installing them in such a manner that the effective spring force partially opposing the pivoting of the supporting surface can be changed.

An embodiment can be seen in FIG. 11 in which a rotatable spindle 25 is provided to which the movable supporting surface 5 is attached. Rotation of the spindle 24 therefore also rotates the supporting surface 5. A spring means which has a limb 26, which can be seen in FIG. 11, is attached in or to the spindle 25. This limb 26 is supported on the base plate 4 of the slide, so that the rotation of the spindle 25 or the pivoting of the supporting surface 5 takes place counter to the force of the spring means. The spring means may be partially embodied, for example, as a spiral spring.

There is furthermore the possibility for the supporting surface 5 to be removable.

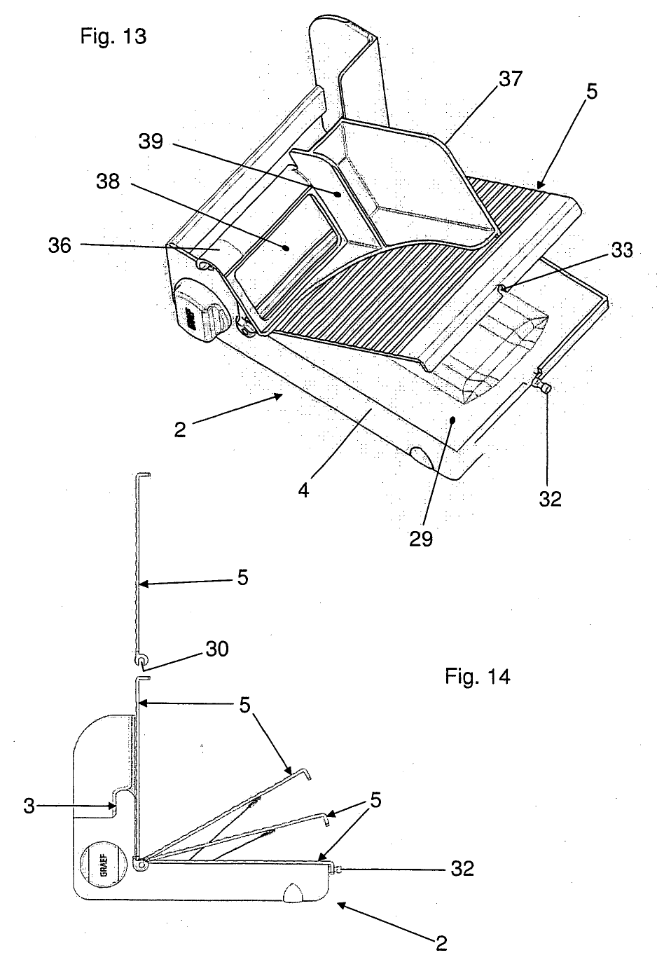

A further embodiment of a cutting machine according to the invention can be seen from FIG. 12 to FIG. 15c, in which the same parts are provided with the same reference numbers as in FIG. 1 to FIG. 11.

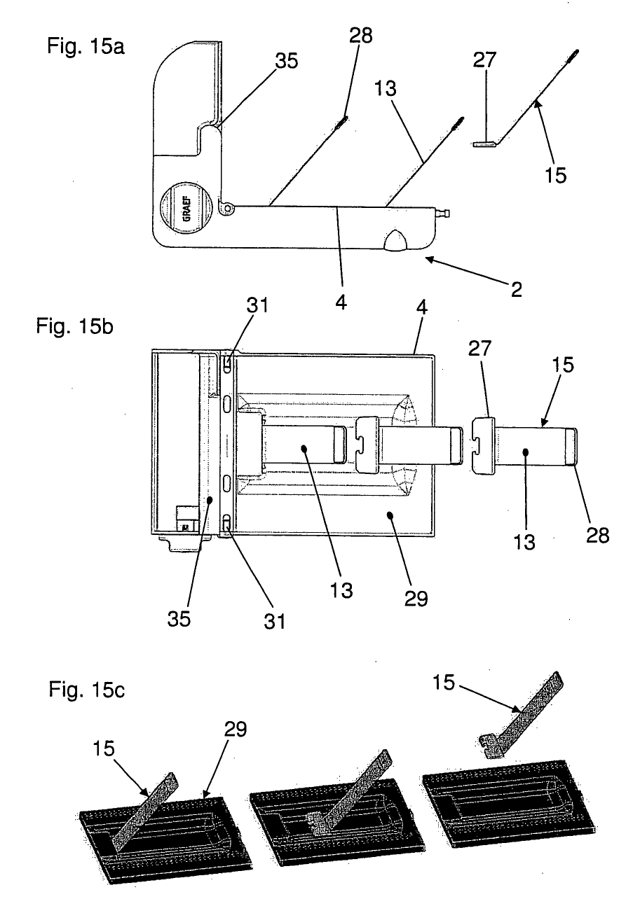

The embodiment depicted in FIG. 12 to FIG. 15c has as spring means a leaf spring 13 which is part of a spring unit 15 (see FIGS. 15a and 15b for this). In addition to the leaf spring 13, the spring unit comprises a plug-in section 27 and noise-reducing means 28.

The leaf spring 13 can be connected at a first end, at the bottom in the operational position, to a covering plate 29 for the base plate 4 of the slide (see FIG. 15c). The covering plate 29 serves to cover the upper side of the base plate 4 and can be clipped onto the latter (see FIG. 15b). The plug-in section 27 is provided at that end of the leaf spring 13 which can be connected to the covering plate 29, and can be, for example, a plastic part which is molded around this end of the leaf spring. The plug-in section 27 may be plugged into a correspondingly shaped receiving section of the covering plate 29. This produces a releasable connection of the spring unit 15 to the covering plate 29 or to the base plate 4.

The noise-reducing means 28 are arranged on that end of the leaf spring 13 which faces away from the covering plate 29. In the operational position, this end and the noise-reducing means 28 surrounding this end bear against the lower side of the supporting surface 5 (see FIG. 12). The noise-reducing means 28 may be an encapsulation, which is composed of plastic, by injection molding of that end of the leaf spring 13 which is at the top in the operational position. This plastic encapsulation by means of injection molding prevents too much noise being produced during the operation of the cutting machine.

It can be seen from FIG. 14 that the supporting surface 5 can be removed, so that it can be cleaned more easily. For this purpose, the supporting surface 5 has, on one of its sides, a recess 30 which can be plugged onto two pins 31 attached to the slide 2. These pins 31 serve at the same time as a pivot axis for the supporting surface 5 (see FIG. 15b for this).

FIG. 14 shows various positions of the supporting surface 5. In one of these positions, the supporting surface 5 is pivoted into the horizontal position and is fixed to the slide 2 via locking means 32. The locking means 32 are designed as a pin which can be pressed into the slide 2 and around which a keyhole-like recess on the supporting surface 5 can engage.

The embodiment according to FIG. 12 to FIG. 15c furthermore has a scraps holder 34 which can be pivoted together with the supporting surface 5. For this purpose, the rear bearing surface 3 has an upper rounded portion 35 (see FIG. 12 and FIG. 15a for this) over which an upper section 36 of the scraps holder 34 engages. The upper section 36 corresponds in terms of its curvature to the upper rounded portion 35, so that the upper section 36 and therefore the scraps holder 34 can be pivoted on the upper rounded portion 35. During the pivoting, the scraps holder 34 here rests partially on the supporting surface 5.

On its side facing the cuttable material, the scraps holder 34 has a bearing wall 37 extending parallel to the cutting plane (see FIG. 12 and FIG. 13) which can be provided (not depicted) on its side facing the cuttable material with points for securing the cuttable material.

On its side parallel to the rear bearing surface 3, the scraps holder 34 has an aperture 38 through which a user's finger can reach while operating the cutting machine. In this case, a user's thumb can rest on that side of the rear bearing surface 3 which faces away from the supporting surface 5 while his fingers protrude over the upper rounded portion 35 or the section 36 engaging over the latter and reach through the aperture 38, so that they rest on that side of the rear bearing surface 3 which faces the supporting surface. That side of the rear bearing surface 3 which is touched by the thumb can have a push-button switch for actuating the cutting machine. The aperture 38 prevents a user, by grasping the scraps holder 34, from pressing the latter and therefore also the bearing surface 5 downward or pivoting them in the clockwise direction in FIG. 12.

Instead of an aperture 38, scraps holder 34 may also have a downwardly open cutout through which the user's fingers can likewise reach.

The scraps holder 34 furthermore has a wall 39 which is parallel to the bearing wall 37 and is adjacent to the aperture 38. The wall 39 prevents a user from placing his fingers next to the aperture on the scraps holder 34 and therefore pressing the latter and also the bearing surface 5 downward.

What is claimed is:

1. A cutting machine for foodstuffs, comprising
a rotatable blade;
a slide which can be moved to and fro; and
a supporting surface for cuttable material to be cut off, which supporting surface is attached movably to the slide and can be transferred from a first position, which encloses an angle not equal to 0° with the horizontal, into a second, horizontal position;
wherein
the cutting machine comprises resetting means which, when the supporting surface moves from the first position to the second position, can exert a resetting force on the supporting surface.

2. The cutting machine as claimed in claim 1, wherein, in the first position, the supporting surface encloses an angle of between 10° and 50°, in particular an angle of between 20° and 30°, with the horizontal.

3. The cutting machine as claimed in claim 1, wherein the supporting surface is pivoted about a pivot axis lying essentially in the plane of the supporting surface.

4. The cutting machine as claimed in claim 1, wherein the pivot axis of the supporting surface is essentially parallel to the axis of rotation of the blade.

5. The cutting machine as claimed in claim 1, wherein the resetting means comprise spring means which make it possible for the supporting surface to pivot in relation to the slide at least partially counter to the force of the spring means.

6. The cutting machine as claimed in claim 5, wherein the spring means are designed in such a manner or are installed in such a manner that the effective spring force at least partially opposing the pivoting of the supporting surface can be changed.

7. The cutting machine as claimed in claim 1, wherein the resetting means comprise at least two magnets which make it possible for the supporting surface to pivot in relation to the slide at least partially counter to the force of the magnets.

8. The cutting machine as claimed in claim 1, wherein the slide has a rear bearing surface with it being possible for cuttable material which is to be cut to be held between the bearing surface and the supporting surface.

9. The cutting machine as claimed in claim 1, wherein at least part of the rear bearing surface can be moved together with the supporting surface.

10. The cutting machine as claimed in claim 9, wherein the movable part of the rear bearing surface encloses an angle of between 60° and 120°, for example of about 90°, with the supporting surface.

11. The cutting machine as claimed in claim 1, wherein the movable supporting surface is fixed or locked in the first position or in both positions.

12. The cutting machine as claimed in claim 1, wherein the movable supporting surface is removed from the cutting machine.

13. The cutting machine as claimed in claim 1, wherein the cutting machine comprises a rotatable spindle to which the movable supporting surface is attached, the spindle being rotatable counter to the force of spring means.

14. The cutting machine as claimed in claim 1, wherein the spring means are a removable spring unit.

15. The cutting machine as claimed in claim 1, wherein the spring means comprise noise-reducing means for damping the connection between the spring means and the supporting surface.

16. The cutting machine as claimed in claim 1, wherein the cutting machine comprises a scraps holder which can be pivoted together with the supporting surface.

17. The cutting machine as claimed in claim 1, wherein the cutting machine comprises a covering plate which can be attached releasably to the base plate.
